(19) United States
(12) Patent Application Publication
(10) Pub. No.: US 2025/0232009 A1
(43) Pub. Date: Jul. 17, 2025

(54) DATASET LABELING USING LARGE LANGUAGE MODEL AND ACTIVE LEARNING

(71) Applicant: Optum, Inc., Minnetonka, MN (US)

(72) Inventors: Saumajit Saha, Bangalore (IN); Prakhar Mishra, Gurgaon (IN); Albert Aristotle Nanda, Bengaluru (IN)

(21) Appl. No.: 18/595,870

(22) Filed: Mar. 5, 2024

(30) Foreign Application Priority Data
Jan. 12, 2024 (IN) 202411002409

(51) Int. Cl. G06F 18/2415; G06F 16/31

(52) U.S. Cl. CPC G06F 18/2415; G06F 16/31

(57) ABSTRACT

Various embodiments of the present disclosure provide methods, apparatus, systems, computing devices, computing entities, and/or the like for labeling data by (i) generating, using a natural language machine learning model, a labeled dataset from unlabeled data, (ii) training one or more instances of a classification machine learning model based on the labeled dataset, (iii) generating, using the one or more instances of the classification machine learning model, a plurality of validation classifications, and (iv) generating a refined labeled dataset that is based on the labeled dataset and a plurality of uncertainty scores associated with the plurality of validation classifications.

### PRIORITY OF FOREIGN APPLICATION

This application claims the priority of IN Provisional Application No. 202411002409, entitled “Labeled Dataset Preparation Using LLM and Active Learning,” filed on Jan. 12, 2024, the disclosure of which is hereby incorporated by reference in its entirety.

### BACKGROUND

Various embodiments of the present disclosure address technical challenges and provide improvements related to the generation of training data for training machine learning models.

In various domain fields, such as in the healthcare industry, issues and inquiries may be received from members that require constant monitoring and understanding to adequately serve the members. Traditional techniques for handling issues and inquiries leverage text analysis tools to extract issues (e.g., clarifications regarding prescription details, etc.) and inquiries (e.g., questions regarding a current prescription status, etc.) from audio and/or textual mediums. For example, automated text classification tools may be employed to classify data, such as issues or inquiries in the form of text segments, into one or more desired categories for resolution.

Building an automated solution for classifying data into categories may require one or more machine learning models that are trained on labeled data. Generally, the ability of a machine learning model to correctly generate predictions/classifications (e.g., accuracy and/or performance of the machine learning model) is directly proportional to the quality of a labeled dataset used to train the machine learning model. Existing techniques used to perform machine-based data labeling, such as pattern mining using regular expressions, weak supervision snorkel, and/or the like, require an extensive amount of domain knowledge to enable the identification of specific patterns to be mapped to specific class labels. This domain knowledge, and the labels assigned using the domain knowledge, is time-specific such that training data labeled at a current time point may become redundant, inaccurate, or misleading as trends and developments occur within a domain. The loss of accuracy and reliability within a training dataset directly impacts the accuracy and reliability of machine learning models trained using the training dataset, such that data drifts over time reduce the performance of traditional machine learning models. This, in turn, reduces the reliability and usability of traditional machine learning tools for automated classification techniques.

Various embodiments of the present disclosure make important contributions to traditional machine-based data labeling techniques by addressing these technical challenges, among others.

### BRIEF SUMMARY

In general, various embodiments of the present disclosure provide methods, apparatus, systems, computing devices, computing entities, and/or the like for generating training data to improve machine learning models.

Various embodiments of the present disclosure make important technical contributions to improving the classification accuracy of classification machine learning models by improving the quality of data labels generated by a natural language machine learning model. As described herein, the accuracy and performance of a machine learning model is dependent on the quality of training data used to train the machine learning model. Some embodiments of the present disclosure map unlabeled data to a corresponding category to ensure a gold-standard quality of annotated data that may be used to train a classification machine learning model. By doing so, some of the techniques of the present disclosure improve efficiency and speed of training classification machine learning models, thus reducing the number of computational operations needed and/or the amount of training data entries needed to train classification machine learning models.

In some embodiments, a computer-implemented method comprises generating, by one or more processors and using a natural language machine learning model, a labeled dataset from unlabeled data based on one or more prompts that are associated with a data labeling task; generating, by the one or more processors, a first instance of a classification machine learning model by determining one or more first parameter values for the first instance of the classification machine learning model based on a training portion of the labeled dataset; generating, by the one or more processors and using the first instance of the classification machine learning model, a plurality of validation classification outputs for a validation portion of the labeled dataset; receiving, by the one or more processors, a refined labeled dataset that is based on the labeled dataset and a plurality of uncertainty scores associated with the plurality of validation classification outputs; generating, by the one or more processors, a second instance of the classification machine learning model by determining one or more second parameter values for the second instance of the classification machine learning model based on the refined labeled dataset; and generating, by the one or more processors and using the second instance of the classification machine learning model, one or more inference classification outputs.

In some embodiments, a computing system comprises memory and one or more processors communicatively coupled to the memory, the one or more processors configured to generate, using a natural language machine learning model, a labeled dataset from unlabeled data based on one or more prompts that are associated with a data labeling task; generate a first instance of a classification machine learning model by determining one or more first parameter values for the first instance of the classification machine learning model based on a training portion of the labeled dataset; generate, using the first instance of the classification machine learning model, a plurality of validation classification outputs for a validation portion of the labeled dataset; receive a refined labeled dataset that is based on the labeled dataset and a plurality of uncertainty scores associated with the plurality of validation classification outputs; generate a second instance of the classification machine learning model by determining one or more second parameter values for the second instance of the classification machine learning model based on the refined labeled dataset; and generate, using the second instance of the classification machine learning model, one or more inference classification outputs.

In some embodiments, one or more non-transitory computer-readable storage media includes instructions that, when executed by one or more processors, cause the one or more processors to generate, using a natural language machine learning model, a labeled dataset from unlabeled data based on one or more prompts that are associated with a data labeling task; generate a first instance of a classification machine learning model by determining one or more first parameter values for the first instance of the classification machine learning model based on a training portion of the labeled dataset; generate, using the first instance of the classification machine learning model, a plurality of validation classification outputs for a validation portion of the labeled dataset; receive a refined labeled dataset that is based on the labeled dataset and a plurality of uncertainty scores associated with the plurality of validation classification outputs; generate a second instance of the classification machine learning model by determining one or more second parameter values for the second instance of the classification machine learning model based on the refined labeled dataset; and generate, using the second instance of the classification machine learning model, one or more inference classification outputs.

### BRIEF DESCRIPTION OF THE DRAWINGS

FIG. 1 provides an example overview of an architecture in accordance with some embodiments of the present disclosure.

FIG. 2 provides an example data analysis computing entity in accordance with some embodiments of the present disclosure.

FIG. 3 provides an example client computing entity in accordance with some embodiments of the present disclosure.

FIG. 4 is a flowchart diagram of an example process for classifying unlabeled inference input data in accordance with some embodiments of the present disclosure.

FIG. 5 is a flowchart diagram of an example process for generating one or more refined label datasets in accordance with some embodiments of the present disclosure.

FIG. 6 depicts an example architecture of a labeled dataset preparation framework in accordance with some embodiments of the present disclosure.

FIG. 7 is a flowchart diagram of an example process for generating refined labeled datasets in accordance with some embodiments of the present disclosure.

FIG. 8 is a data flow diagram of an example data labeling architecture in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

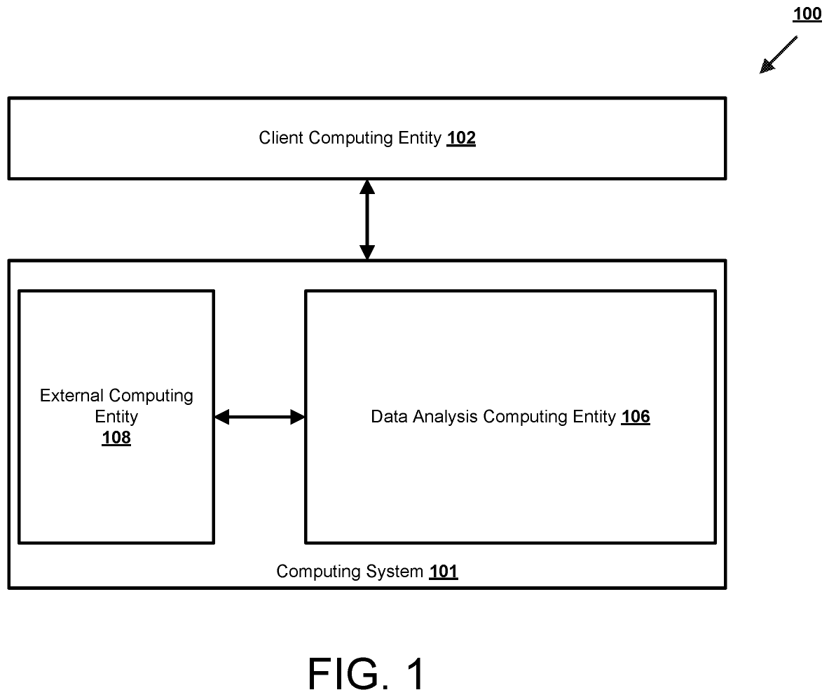

FIG. 1 provides an example overview of an architecture 100 in accordance with some embodiments of the present disclosure. The architecture 100 includes a computing system 101 configured to receive data classification requests from client computing entity 102, process the data classification requests to generate classification outputs, and provide the generated classification outputs to the client computing entity 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more labeled datasets are generated from unlabeled data by a natural language machine learning model based on one or more prompts that are associated with a data labeling task. A training portion of the one or more labeled datasets may be used to train a classification machine learning model. The trained classification machine learning model may be used to generate a plurality of validation classification outputs of a validation portion of the labeled datasets. The plurality of validation classification outputs may be analyzed for uncertainty whereby one or more refined labeled datasets may be generated from the one or more labeled datasets and used to fine-tune the classification machine learning model. This technique will improve the accuracy of machine learning models relative to traditional machine learning training techniques. In doing so, the techniques described herein improve efficiency and speed of training classification machine learning models, thus reducing the number of computational operations needed and/or the amount of training data entries needed to train classification machine learning models. Accordingly, the techniques described herein improve the computational efficiency, storage-wise efficiency, and speed of training classification machine learning models.

In some embodiments, the computing system 101 may communicate with at least one of the client computing entity 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a data analysis computing entity 106 and one or more external computing entities 108. The data analysis computing entity 106 and/or one or more external computing entities 108 may be individually and/or collectively configured to receive data classification requests from client computing entity 102, process the data classification requests to generate classification outputs, and provide the generated classification outputs to the client computing entity 102.

For example, as discussed in further detail herein, the data analysis computing entity 106 and/or one or more external computing entities 108 comprise storage subsystems that may be configured to store input data, training data, and/or the like that may be used by the respective computing entities to perform data analysis, classification, data labeling, training and/or fine-tuning operations of the present disclosure. In addition, the storage subsystems may be configured to store model definition data used by the respective computing entities to perform various data analysis, classification, data labeling, training and/or fine-tuning tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the data analysis computing entity 106 and/or one or more external computing entities 108 are communicatively coupled using one or more wired and/or wireless communication techniques. The respective computing entities may be specially configured to perform one or more steps/operations of one or more techniques described herein. By way of example, the data analysis computing entity 106 may be configured to train, implement, use, update/fine-tune, and evaluate machine learning models in accordance with one or more training and/or prediction operations of the present disclosure. In some examples, the external computing entities 108 may be configured to train, implement, use, update/fine-tune, and evaluate machine learning models in accordance with one or more training and/or prediction operations of the present disclosure.

In some example embodiments, the data analysis computing entity 106 may be configured to receive and/or transmit one or more datasets, objects, and/or the like from and/or to the external computing entities 108 to perform one or more steps/operations of one or more techniques (e.g., data synthesis techniques, labeling techniques, classification techniques, and/or the like) described herein. The external computing entities 108, for example, may include and/or be associated with one or more entities that may be configured to receive, transmit, store, manage, and/or facilitate datasets, such as labeled and/or unlabeled datasets, and/or the like. The external computing entities 108, for example, may include data sources that may provide such datasets, and/or the like to the data analysis computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the data analysis computing entity 106 to obtain and aggregate data for a prediction domain.

In some example embodiments, the data analysis computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the data analysis computing entity 106, which may leverage the trained machine learning model to perform one or more prediction steps/operations of the present disclosure. In some examples, feedback (e.g., evaluation data, ground truth data, etc.) from the use of the machine learning model may be recorded by the data analysis computing entity 106. In some examples, the feedback may be provided to the one or more external computing entities 108 to continuously train (or fine-tune) the machine learning model over time. In some examples, the feedback may be leveraged by the data analysis computing entity 106 to continuously train the machine learning model over time. In this manner, the computing system 101 may perform, via one or more combinations of computing entities, one or more prediction, training, and/or any other machine learning-based techniques of the present disclosure.

### A. Example Data Analysis Computing Entity

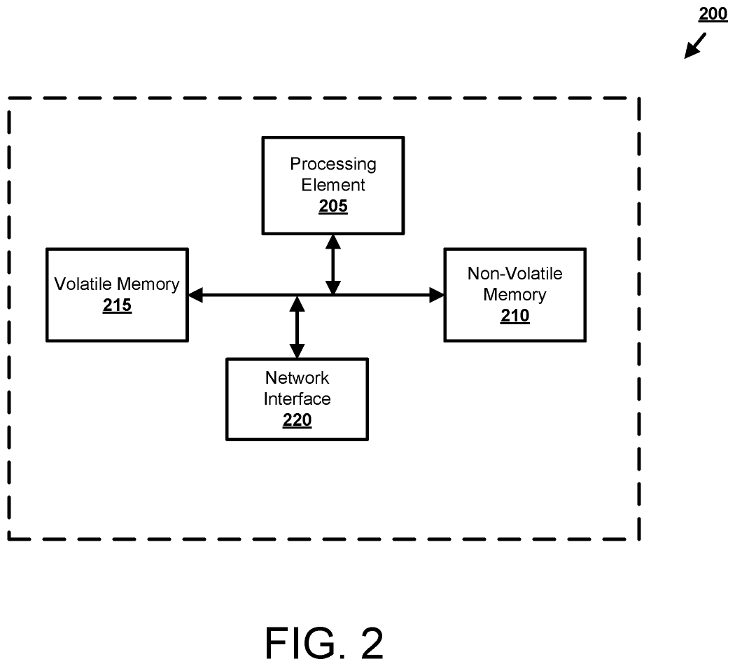

FIG. 2 provides an example computing entity 200 in accordance with some embodiments of the present disclosure. The computing entity 200 is an example of the data analysis computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training, or fine-tuning one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., data analysis computing entity 106, etc.) may train and use one or more machine learning models described herein. In other embodiments, a first computing entity (e.g., data analysis computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized parameters, weights, code sets, etc.) to the first computing entity over a network.

As shown in FIG. 2, in some embodiments, the data analysis computing entity 106 may include, or be in communication with, one or more processing elements 205 (also referred to as processor(s), processing circuitry, and/or similar terms used herein interchangeably) that communicate with other elements within the data analysis computing entity 106 via a bus, for example. As will be understood, the processing elements 205 may be embodied in a number of different ways.

For example, the processing elements 205 may be embodied as one or more complex programmable logic devices (CPLDs), microprocessors, multi-core processors, coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. Thus, the processing elements 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like being executed by, for example, the processing elements 205. Thus, the databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like may be used to control certain aspects of the operation of the computing entity 200 with the assistance of the processing elements 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

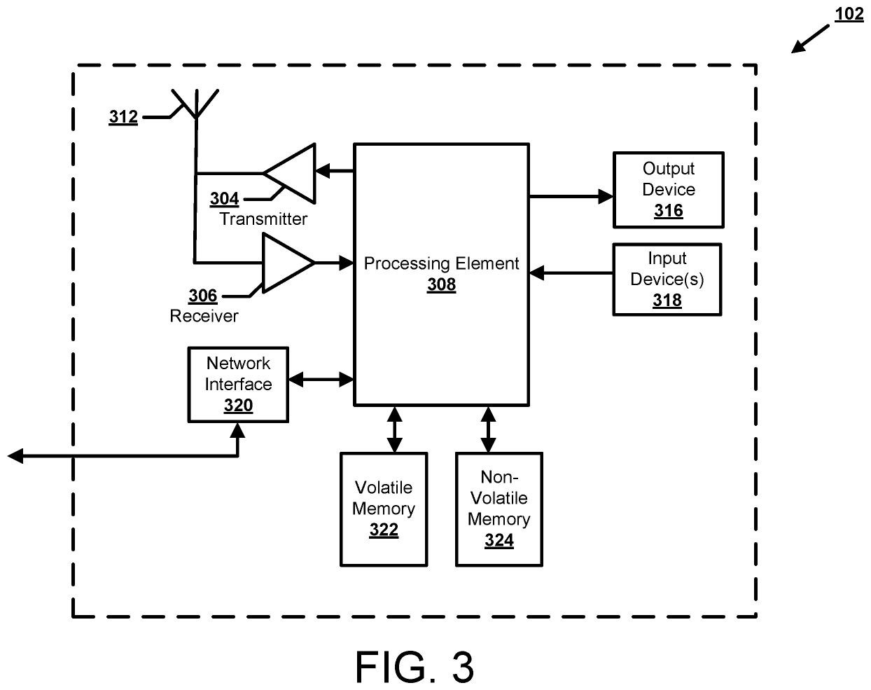

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entity 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “labeled dataset” refers to a data construct that describes a set of data comprising data that is associated or assigned with informative labels. A labeled dataset may be generated by assigning one or more labels to unlabeled data. In some embodiments, generating a labeled dataset comprises assigning, using a natural language machine learning model, one or more labels to unlabeled data. For example, a natural language machine learning model comprising a generative pre-trained transformer, such as a large language model (LLM), may be configured to generate a labeled dataset when provided with unlabeled data and one or more prompts that are associated with a data labeling task of the unlabeled data. Various techniques may be used to generate labeled datasets. In some embodiments, generating one or more labeled datasets comprises assigning one or more labels to a subset of unlabeled data based on data labeling performed by a natural language machine learning model (e.g., via one or more of zero-shot prompting or few-shot prompting) or manual annotation.

In some embodiments, the term “label” refers to a data construct that describes a description, tag, or identifier that classifies or represents one or more features associated with a data. For example, a label may be associated with a class that describes an alignment or characterization of data. According to various embodiments of the present disclosure, a labeled dataset is generated by assigning one or more labels to unlabeled data. In some embodiments, a label may provide a ground truth to a classification machine learning model, e.g., for training the classification machine learning model. A classification machine learning model may be trained to generate a classification output based on an observation of one or more labels with respect to one or more data features during training with training data comprising one or more labeled datasets. In some embodiments, a label comprises a categorization of data. For example, a classification machine learning model may be trained to generate a classification output for inference input data based on training data comprising a labeled dataset of data that is labeled based on one or more categories.

In some embodiments, the term “unlabeled data” refers to a data construct that describes data that is not associated or assigned with one or more labels. For example, unlabeled data may comprise an unlabeled corpus of sentences, words, or phrases that is collected from documents, messages, electronic forms, websites, call transcripts, or any other data source. According to various embodiments of the present disclosure, one or more labeled datasets are generated by assigning one or more labels to unlabeled data.

In some embodiments, the term “data labeling” refers to an assignment of one or more labels to unlabeled data (e.g., to generate one or more labeled datasets). According to various embodiments of the present disclosure, a natural language machine learning model is configured to perform data labeling of unlabeled data based on one or more prompts.

In some embodiments, the term “prompt” refers to a data construct that describes information comprising one or more instructions that may be used to interact with a natural language machine learning model, such as an LLM, to define a desired task and/or output from the natural language machine learning model. That is, a prompt may be used to provide a natural language machine learning model with information the machine learning model needs to perform a task or generate an output. For example, a prompt may comprise a task description and optionally one or more examples to help a natural language machine learning model understand how to generate an output. In some embodiments, a prompt comprises a zero-shot prompt or a few-shot prompt. According to various embodiments of the present disclosure, a natural language machine learning model may generate a labeled dataset from unlabeled data based on a prompt that are associated with a data labeling task.

In some embodiments, the term “train” or “training” refers to a process of providing a machine learning model with training data such that the machine learning model may identify patterns in the training data that map one or more features to a target (e.g., a label). Training a machine learning model may comprise modifying one or more parameters of the machine learning model to store or capture patterns identified from training data. For example, one or more parameters of a machine learning model may be modified during training based on an observation of training data (e.g., a labeled dataset) comprising one or more data features and one or more labels that are associated with the one or more data features. The one or more parameters may be modified using one or more training techniques, such as back propagation of errors, gradient descent, and/or the like, to optimize a model with respect to one or more targets within the training data. According to various embodiments of the present disclosure, modifying one or more parameters of a machine learning model comprises determining one or more parameter values.

In some embodiments, the term “training data” refers to data that is used to train a machine learning model to perform a desired task (e.g., a classification or prediction). A machine learning model (and its parameters) may be configured to learn (or trained on) features associated with training data. For example, training data may comprise data (e.g., a labeled dataset) including example associations between one or more features and respective one or more labels, wherein the one or more labels comprise ground truths (e.g., classifications) with respect to the one or more features. In some embodiments, training data is divided into a training dataset, a fine-tuning dataset, and/or the like. In some examples, a training dataset may include a training portion of one or more labeled datasets. In addition, or alternatively, a fine-tuning dataset may include a validation portion of the one or more labeled datasets.

In some embodiments, the term “training portion” refers to a portion of one or more labeled datasets that is allocated for training a machine learning model.

In some embodiments, the term “validation portion” refers to a portion of one or more labeled datasets that is allocated for validation and fine-tuning a machine learning model.

In some embodiments, the term “fine-tuning” refers to additional training of a previously trained machine learning model that is performed to update one or more parameters of the trained machine learning model to reflect new or updated data (e.g., refined labeled datasets). In some embodiments, fine-tuning comprises modifying one or more parameters of a machine learning model by determining one or more parameter values based on one or more refined labeled datasets.

In some embodiments, the term “parameter” refers to a data construct that describes a configuration variable of a machine learning model that is used by the machine learning model to generate a classification output. A parameter may comprise a value (i.e., a parameter value) that is estimated or learned from training data. For example, one or more parameters may be modified via one or more parameter values that determined are based on training with training data (e.g., a labeled dataset) that comprises one or more data features and one or more labels associated with the one or more data features. As such, a trained machine learning model may comprise one or more parameters that may be used to generate classification outputs for inference input data by mapping one or more features of the inference input data to targets (e.g., labels) based on one or more labels from training data.

In some embodiments, the term “instance” refers to an iteration of a data construct, such as a machine learning model. For example, a plurality of instances of a classification machine learning model may be generated and trained with a respective plurality of labeled datasets such that each instance of the classification machine learning model may perform differently depending on the labeled dataset used for training. As such, a quality of the plurality of labeled datasets may be determined and compared among the plurality of instances of the classification machine learning model. In some embodiments, the plurality of labeled datasets may be generated by a natural language machine learning model using various prompts. By modifying prompts that are provided to a natural language machine learning model, unique labeled datasets may be obtained and used to generate and train a plurality of instances of a classification machine learning model. Hence, the quality of the unique labeled datasets, and by extension, the prompts used to generate the unique labeled datasets may be determined and compared by analyzing classification outputs generated by the plurality of instances of the classification machine learning model.

In some embodiments, the term “inference input data” refers to data that is provided to a machine learning model to generate a classification output. For example, inference input data may comprise unlabeled data that is provided to a machine learning model (e.g., trained with one or more labeled datasets) to generate a classification output.

In some embodiments, the term “classification output” refers to a data construct that describes an output generated by a classification machine learning model. For example, a classification machine learning model may be trained to generate a classification output for inference input data. Generating a classification output may comprise determining one or more probabilities (e.g., a probability distribution) of an inference input data object being correctly assigned to one or more labels. In some embodiments, a classification output comprises a label that is assigned to an inference input data object.

In some embodiments, the term “refined labeled dataset” refers to a labeled dataset that has been modified or revised based on a determination of inaccuracy of the labeled dataset or an improvement to the labeled dataset. For example, one or more labels that are assigned to data in a labeled dataset may be added, replaced, or removed in a manner that improves an overall quality and/or accuracy of the labeled dataset. In some embodiments, one or more refined labeled datasets are generated from one or more labeled datasets based on an analysis of a plurality of validation classification outputs that are generated by one or more instances of a machine learning model that are trained with training data based on the one or more labeled datasets. In some embodiments, the analysis of the plurality of validation classification outputs comprises determining one or more uncertain classifications from the plurality of validation classification outputs. In some embodiments, the one or more refined labeled datasets are generated based on one or more human-in-the-loop processes, such as manual revision of the one or more labeled datasets (e.g., add, replace, or remove labels) based on a review of the one or more uncertain classifications. In some embodiments, a machine learning model is fine-tuned based on one or more refined labeled datasets.

In some embodiments, the term “uncertain classification” refers to a data construct that describes a classification or classification output generated by a classification machine learning model that is determined to be potentially inaccurate. In some embodiments, uncertain classifications are determined by performing uncertainty sampling on a plurality of classifications or determining a plurality of classification margins for the plurality of validation classification outputs (e.g., generated by one or more instances of a machine learning model that are trained with training data based on one or more labeled datasets).

In some embodiments, the term “uncertainty score” refers to a data value that reflects an uncertainty with a validation classification output. An uncertainty score may be based on a prediction probability and/or a margin of prediction probabilities output by a machine learning model.

In some embodiments, the term “uncertainty sampling” refers to a determination of one or more uncertain classifications from a plurality of validation classification outputs based on a plurality of probability distributions (e.g., determined by a classification machine learning model during inference) associated with the plurality of validation classification outputs. Uncertainty sampling may comprise generating a plurality of uncertainty scores for a plurality of validation classification outputs, which may then be used to determine given ones of the plurality of validation classification outputs comprising highest (e.g., top percentile or exceeding a threshold) uncertainty scores. In some embodiments, uncertainty sampling is performed by (i) determining a plurality of prediction probabilities associated with a plurality of validation classification outputs and (ii) generating a plurality of uncertainty scores for the plurality of validation classification outputs based on the plurality of prediction probabilities. An uncertainty score, for example, may include the prediction probability and/or an inverse of the prediction probability for a validation classification output. For example, an uncertainty score (e.g., 0.3, etc.) may reflect margin between a prediction probability (e.g., 0.7, etc.) and an upper limit (e.g., 1, etc.) for the prediction probability. In such a case, an uncertain classification may be assigned to a validation classification output with an uncertainty score that exceeds a threshold uncertainty (e.g., 0.2, etc.).

In some embodiments, the term “classification margin” refers to a margin between the prediction probabilities for one or more classifications output by a machine learning model for a validation data object from the validation portion of the one or more labeled datasets. The classification margin, for example, may include an uncertainty score for a particular validation classification output. In this case, the uncertainty score may be determined from a plurality of probability distributions (e.g., determined by a classification machine learning model during inference) associated with the plurality of validation classification outputs. Classifications comprising low classification margin may be prone to having incorrect ground truths. That is, a low classification margin may be representative of a classification where a first probable class and a second most probable class that are determined and used as a basis for performing the classification are almost equally likely, thereby resulting in a classification that is highly uncertain. In some embodiments, a classification margin is determined for a classification by (i) determining a first most likely prediction and a second most likely prediction associated with the classification and (ii) determining a difference between the first most likely prediction and the second most likely prediction.

In some embodiments, the term “classification machine learning model” refers to a data construct that describes parameters, hyperparameters, and/or defined operations of a machine learning model that is configured to generate one or more classification outputs for input data. In some embodiments, (i) a classification machine learning model is trained by determining one or more first parameter values that are associated with the classification machine learning model based on a training portion of one or more labeled datasets and (ii) the classification machine learning model is used to generate a plurality of validation classification outputs for a validation portion of the one or more labeled datasets based on one or more first parameter values. In some embodiments, (i) a classification machine learning model is fine-tuned by determining one or more second parameter values that are associated with the classification machine learning model based on one or more refined labeled datasets and (ii) the classification machine learning model is used to generate one or more inference classification outputs for inference input data based on the one or more second parameter values. In some embodiments, a classification machine learning model is configured to generate one or more classification outputs that comprise a label selected from a plurality of labels. For example, a classification machine learning model may select a label from among two labels to perform binary classification, or a classification machine learning model may select a label from among three or more labels to perform multi-class classification.

In some embodiments, the term “natural language machine learning model” refers to a data construct that describes parameters, hyperparameters, and/or defined operations of a machine learning model that is configured to perform a task and/or generate an output based on one or more prompts. A natural language machine learning model may comprise a generative pre-trained transformer, such as an LLM. In some embodiments, a natural language machine learning model is used to generate one or more labeled datasets from unlabeled data based on one or more prompts that are associated with a data labeling task.

### IV. OVERVIEW

Various embodiments of the present disclosure make important technical contributions to machine learning that address the efficiency and reliability shortcomings of existing machine learning training techniques. For example, some techniques of the present disclosure improve the classification accuracy of classification machine learning models used in classifying unlabeled data. To do so, a training feedback loop mechanism is leveraged to train a classification machine learning model to generate classification outputs based on training data that comprises one or more labeled datasets that are generated by a natural language machine learning model and refined based on a determination of uncertain classifications. By doing so, some of the techniques of the present disclosure improve the training speed, efficiency, and adaptability of training classification machine learning models which, in turn, improves the classification performance of the resulting models.

It is well-understood in the relevant art that there is typically a tradeoff between accuracy and training speed, such that it is trivial to improve training speed by reducing accuracy. Thus, the challenge is to improve training speed without sacrificing accuracy through innovative machine learning model architectures and training techniques. Accordingly, some of the techniques of the present disclosure that improve accuracy without harming training speed, such as the techniques described herein, enable improving training speed given an improved accuracy. In doing so, some of the techniques described herein improve efficiency and speed of training classification machine learning models, thus reducing the number of computational operations needed and/or the amount of training data entries needed to train classification machine learning models. Accordingly, some of the techniques described herein improve the computational efficiency, storage-wise efficiency, and/or speed of training machine learning models, while improving the model's performance.

Various embodiments of the present disclosure improve classification accuracy of classification machine learning models by improving the quality of data labels generated by a natural language machine learning model. As described herein, the accuracy and performance of a machine learning model is dependent on the quality of training data used to train the machine learning model. In particular, the better the quality of labeled data, the better a machine learning model may be able to correctly perform a desired classification task. For example, given an unlabeled corpus of sentences and a list of probable class labels, the goal is to map each sentence from the unlabeled corpus to its corresponding category to ensure a gold-standard quality of annotated data that may be used to train a classification machine learning model.

In accordance with various embodiments of the present disclosure, one or more labeled datasets are generated from unlabeled data by a natural language machine learning model based on one or more prompts that are associated with a data labeling task. A training portion of the one or more labeled datasets may be used to train a classification machine learning model. The trained classification machine learning model may be used to generate a plurality of validation classification outputs for a validation portion of the labeled datasets. The plurality of validation classification outputs may be analyzed for uncertainty whereby one or more refined labeled datasets may be generated from the one or more labeled datasets and used to fine-tune the classification machine learning model. In this manner, some of the techniques of the present disclosure, improve accuracy of performing data classification operations.

In accordance with various embodiments of the present disclosure, a classification machine learning model is configured to generate a plurality of validation classification outputs based on training with one or more labeled datasets that are generated by a natural language machine learning, whereby uncertain classifications of the plurality of validation classification outputs generated by the classification machine learning model are used to refine the one or more labeled datasets. By doing so, the accuracy of the one or more labeled datasets may be intelligently determined and provided as feedback to generate one or more refined labeled datasets. In this way, some of the techniques of the present disclosure may be practically applied to improve on the quality of the one or more labeled datasets generated by a natural language machine learning model as well as the performance of a classification machine learning model trained on the one or more labeled datasets.

Moreover, some of the techniques (e.g., the data labeling techniques, classification techniques, fine-tuning techniques, etc.) of the present disclosure may be applied to improve efficiency and speed of training classification machine learning models. This, in turn, reduces the number of computational operations needed and/or the amount of training data entries needed to train classification machine learning models. Accordingly, the techniques described herein improve the computational efficiency, storage-wise efficiency, and/or speed of training classification machine learning models. Other technical improvements and advantages may be realized by one of ordinary skill in the art.

Examples of technologically advantageous embodiments of the present disclosure include: (i) classification machine learning model techniques that leverage unique sets of labeled data to generate improved classification, (ii) refinement techniques for generating improved machine learning model parameters, (iii) machine learning training and fine-tuning techniques for improving model accuracy while reducing computational resource usage, (iv) training feedback loop mechanisms that leverage model outputs to improve training data labels, among others. Other technical improvements and advantages may be realized by one of ordinary skill in the art.

### V. EXAMPLE SYSTEM OPERATIONS

As indicated, various embodiments of the present disclosure make important technical contributions to improving the classification accuracy of classification machine learning models by improving the quality of data labels generated by a natural language machine learning model. By doing so, the accuracy of the one or more labeled datasets may be intelligently determined and provided as feedback to generate one or more refined labeled datasets. In this way, some of the techniques of the present disclosure may be practically applied to improve on the quality of the one or more labeled datasets generated by a natural language machine learning model as well as the performance of a classification machine learning model trained on the one or more labeled datasets.

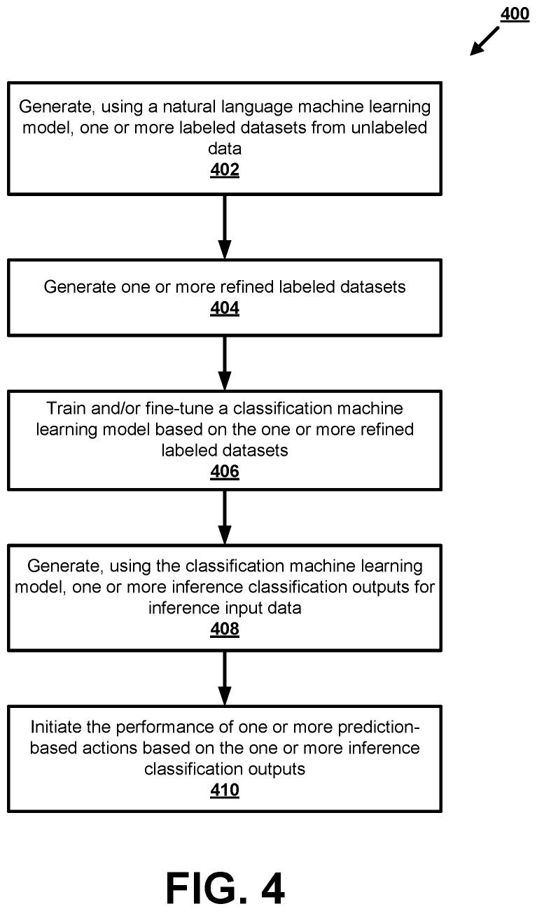

FIG. 4 is a flowchart diagram of an example process 400 for classifying unlabeled inference input data in accordance with some embodiments of the present disclosure.

In some embodiments, via the various steps/operations of the process 400, the computing entity 200 may use a labeled dataset preparation framework to generate one or more labeled datasets from unlabeled data and use the one or more labeled datasets to train and fine-tune a classification machine learning model that is configured to generate one or more inference classification outputs for inference input data.

In some embodiments, the process 400 begins at step/operation 402 when the computing entity 200 generates, using a natural language machine learning model, one or more labeled datasets from unlabeled data.

In some embodiments, a labeled dataset describes a set of data comprising data that is associated or assigned with informative labels. A labeled dataset may be generated by assigning one or more labels to unlabeled data. Various techniques may be used to generate labeled datasets. In some embodiments, generating one or more labeled datasets comprises assigning one or more labels to a subset of unlabeled data based on data labeling performed by a natural language machine learning model (e.g., via one or more of zero-shot prompting or few-shot prompting) or manual annotation.

In some embodiments, a label describes a description, tag, or identifier that classifies or represents one or more features associated with a data. For example, a label may be associated with a class that describes an alignment or characterization of data. According to various embodiments of the present disclosure, a labeled dataset is generated by assigning one or more labels to unlabeled data. In some embodiments, a label may provide a ground truth to a classification machine learning model, e.g., for training the classification machine learning model. A classification machine learning model may be trained to generate a classification output based on an observation of one or more labels with respect to one or more data features during training with training data comprising one or more labeled datasets. In some embodiments, a label comprises a categorization of data. For example, a classification machine learning model may be trained to generate a classification output for inference input data based on training data comprising a labeled dataset of data that is labeled based on one or more categories.

In some embodiments, unlabeled data comprises data that is not associated or assigned with one or more labels. For example, unlabeled data may comprise an unlabeled corpus of sentences, words, or phrases that is collected from documents, messages, electronic forms, websites, call transcripts, or any other data source.

In some embodiments, a natural language machine learning model describes parameters, hyperparameters, and/or defined operations of a machine learning model that is configured to perform a task and/or generate an output based on one or more prompts that are associated with a data labeling task. In some embodiments, data labeling describes an assignment of one or more labels to unlabeled data (e.g., to generate one or more labeled datasets). According to various embodiments of the present disclosure, a natural language machine learning model is configured to perform data labeling of unlabeled data based on one or more prompts. In some embodiments, generating a labeled dataset comprises (i) providing one or more prompts to a natural language machine learning model and (ii) generating a labeled dataset via the natural language machine learning model assigning one or more labels to the unlabeled dataset based on the one or more prompts.

In some embodiments, a prompt comprises information comprising one or more instructions that may be used to interact with a natural language machine learning model, such as an LLM, to define a desired task and/or output. That is, a prompt may be used to provide a natural language machine learning model with information the machine learning model needs to perform a task or generate an output. For example, a prompt may comprise a task description and optionally one or more examples to help a natural language machine learning model understand how to perform a task or generate an output. In some embodiments, a prompt comprises a zero-shot prompt or a few-shot prompt.

A zero-shot prompt may comprise a task description that includes an input sample. As such, zero-shot prompting may exploit the inherent knowledge of a natural language machine learning model to provide output for the input sample. No help is provided to a natural language machine learning model in the form of input-output pairs as examples in a zero-shot prompt. The following is an example of a zero-shot prompt for generating labeled data:
context=f“““Assuming yourself to be an expert in classifying sentence into one of the categories, identify the categories into which the sentences given in the input list belong to. Input is present in {text}. Please ensure:
1. Each sentence should belong to only one category.
2. The definitions of each category are given as follows:
   1. prescription—change pharmacy-other: When patient calls to change their pharmacy for any reason;
   2. prescription—change Rx other: When patient/pharmacy calls to change their prescription (alternative medicine/out of stock and similar);
   3. prescription-need additional Rx info: Caller/Pharmacy asking for additional information regarding a prescription or when there are modifications needed to be made in dosage or frequency of medicines or Incorrect number of prescriptions received by pharmacy;
   4. prescription—pharmacy did not receive: When pharmacy did not receive the prescription or patient advises it was not sent or it needs to be resent;
   5. prescription—refill request: Prescription refill request;
   6. prescription call: Unspecified prescription call;
   7. prescription—prior auth: Prescription issues that are requiring a prior authorization;
   8. prescription status inquiry: wants to know the current status of the prescription or confirms the prescription status; and
   9. prescription—Rx-Not Covered: Rx not covered by insurance.
3. Following the above categories as well as their corresponding definitions, classify each sentence present in the input list into one of the categories.
4. Output format should be: <sentence> ### category.
5. Do NOT break this output format.
6. Do NOT add any extra category. If information is insufficient, look for the most suitable category based on the given information.”””

```
msgs = [
      {
        “role”: “system”,
        “content”: context
      },
      {
        “role”: “user”,
        “content”: f“Resolution texts: {text}
  Output:”
      }
    ]
```

A few-shot prompt may comprise a task description that is similar to a zero-shot prompt but further includes a few examples (e.g., one or more input-output pair examples that are associated with a description of the data labeling task) to help a natural language machine learning model understand a desired task better. The following is an example of a few-shot prompt for generating labeled data:
context=f“““Assuming yourself to be an expert in classifying sentence into one of the categories, identify the categories into which the sentences given in the input list belong to. Input is present in {text}. Please ensure:
1. Each sentence should belong to only one category.
2. The definitions of each category are given as follows:
   1. prescription—change pharmacy-other: When patient calls to change their pharmacy for any reason;
   2. prescription—change Rx other: When patient/pharmacy calls to change their prescription (alternative medicine/out of stock and similar);
   3. prescription-need additional Rx info: Caller/Pharmacy asking for additional information regarding a prescription or when there are modifications needed to be made in dosage or frequency of medicines or Incorrect number of prescriptions received by pharmacy;
   4. prescription—pharmacy did not receive: When pharmacy did not receive the prescription or patient advises it was not sent or it needs to be resent;
   5. prescription—refill request: Prescription refill request;
   6. prescription call: Unspecified prescription call;
   7. prescription—prior auth: Prescription issues that are requiring a prior authorization;
   8. prescription status inquiry: wants to know the current status of the prescription or confirms the prescription status; and
   9. prescription—Rx-Not Covered: Rx not covered by insurance.
3. Following the above categories as well as their corresponding definitions, classify each sentence present in the input list into one of the categories.
4. Output format should be: <sentence> ### category
5. Do NOT break this output format.
6. Do NOT add any extra category. If information is insufficient, look for the most suitable category based on the given information.
Examples
   1. patient called in because they didn't have prescription available at any pharmacy; is asking to change it ### prescription—change Rx other.
   2. mother of the patient is requesting to change the prescription to a generic one or other prescription that is cheaper ### prescription—change Rx other.
   3. patient called the pharmacy and they never got the prescription of amoxicillin from the doctor. looked in tod and not seeing a prescription at all ### prescription—pharmacy did not receive.
   4. patient called in stated that the pharmacy he got his prescriptions sent to doesn't have them ### prescription—pharmacy did not receive.
   5. pharmacy is closed-change pharmacy to: name: peoples pharmacy address: 65 mott st. ny, ny 10013 phone: 2122850977 ### prescription—change pharmacy-other.
   6. patient would like to have prescription of ofloxacin 0.3% eye drops sent to another pharmacy. new address below. ### prescription—change pharmacy-other.
   7. pharmacy needs clarification on prescription instructions, once a day vs twice a day ### prescription-need additional Rx info.
   8. called regarding prescription and to message son provider ### prescription-need additional Rx info.
   9. CVS calling in for patient needs prior authorization for monjauro prescription ### prescription—prior auth.
   10. member called in about the pre auth that needs to be filled out by the provider for the prescription of the member ### prescription—prior auth.
   11. pharmacy stated needed refill for patient on medication ### prescription—refill request.
   12. patient is needing citalopram (celexa) 10 mg tablet sent to CVS pharmacy on file so he can pick up last refill ### prescription—refill request.
   13. patient only received 1 prescription and was to receive 2 of them ### prescription-need additional Rx info.
   14. pt would like to check the status of her pa for her prescription ### prescription status inquiry.
   15. member called to know here his prescription ### prescription status inquiry.
   16. RX not covered by insurance/RX is not covered by insurance/request for alternative RX or pls communicate with insurance as to why is it not covered whichever is applicable ### prescription—Rx-Not Covered.
   17. Member was prescribed Macrobid 100 mg capsule and insurance is not covering. member is wanting to know pharmacy that will take insurance ### prescription—Rx-Not Covered.”””

```
msgs = [
    {
      “role”: “system”,
      “content”: context
    },
    {
      “role”: “user”,
      “content”: f“Resolution texts: {text}
        Output: ”
    }
  ]
```

In some embodiments, at step/operation 404, the computing entity 200 generates one or more refined labeled datasets. Accordingly, in some embodiments, via performing step/operation 404, the computing entity 200 uses the labeled dataset preparation framework to (i) generate and train one or more instances of a classification machine learning model based on one or more labeled datasets, (ii) generate, using the one or more instances of the classification machine learning model, a plurality of validation classification outputs, and (iii) generate one or more refined labeled datasets that are based on the one or more labeled datasets and a plurality of uncertainty scores associated with the plurality of validation classification outputs.

In some embodiments, a refined labeled dataset comprises a labeled dataset that has been modified or revised based on a determination of inaccuracy of the labeled dataset or an improvement to the labeled dataset. For example, one or more labels that are assigned to data in a labeled dataset may be added, replaced, or removed in a manner that improves an overall quality and/or accuracy of the labeled dataset. In some embodiments, one or more refined labeled datasets are generated from one or more labeled datasets based on an analysis of a plurality of validation classification outputs that are generated by one or more instances of a machine learning model that are trained with training data based on the one or more labeled datasets. In some embodiments, the analysis of the plurality of validation classification outputs comprises determining one or more uncertain classifications from the plurality of validation classification outputs. In some embodiments, the one or more refined labeled datasets are generated based on one or more human-in-the-loop processes, such as manual revision of the one or more labeled datasets (e.g., add, replace, or remove labels) based on a review of the one or more uncertain classifications.

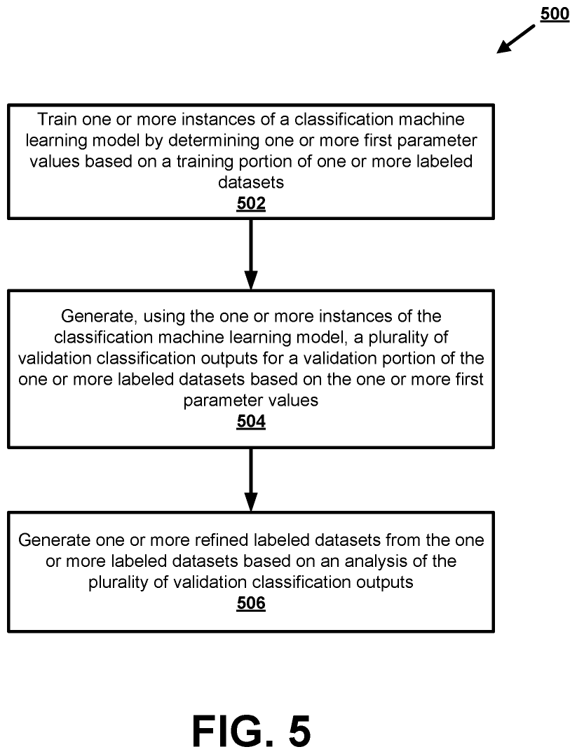

In some embodiments, step/operation 404 may be performed in accordance with the process depicted in FIG. 5. FIG. 5 is a flowchart diagram of an example process 500 for generating one or more refined label datasets in accordance with some embodiments of the present disclosure.

In some embodiments, the process 500 begins at step/operation 502 when the computing entity 200 trains one or more instances of a classification machine learning model by using the labeled dataset preparation framework to determine one or more first parameter values for the one or more instances of the classification machine learning model based on a training portion of one or more labeled datasets. The determined one or more first parameter values may comprise values for one or more parameters that are associated with respective instances of the machine learning model. In some embodiments, a training portion of the one or more labeled datasets comprises a portion of the one or more labeled datasets (e.g., a training dataset) that is allocated for training a machine learning model.

In some embodiments, a parameter describes a configuration variable of a machine learning model that is used by the machine learning model to generate a classification output. A parameter may comprise a value (i.e., a parameter value) that is estimated or learned from training data. For example, one or more parameters may be modified via one or more parameter values that determined are based on training with training data (e.g., a labeled dataset) that comprises one or more data features and one or more labels associated with the one or more data features. As such, a trained machine learning model may comprise one or more parameters that may be used to generate classification outputs for inference input data by mapping one or more features of the inference input data to targets (e.g., labels) based on one or more labels from training data.

In some embodiments, training data comprises data that is used to train a machine learning model to perform a desired task (e.g., generate classification outputs). A machine learning model (and its parameters) may be configured to learn (or trained on) features associated with training data. For example, training data may comprise data (e.g., a labeled dataset) including example associations between one or more features and respective one or more labels, wherein the one or more labels comprise ground truth (e.g., classifications) with respect to the one or more features.

In some embodiments, an instance comprises an iteration of a data construct, such as a machine learning model. For example, a plurality of instances of a classification machine learning model may be generated and trained with a respective plurality of labeled datasets such that each instance of the classification machine learning model may perform differently depending on the labeled dataset used for training. As such, a quality of the plurality of labeled datasets may be determined and compared among the plurality of instances of the classification machine learning model. In some embodiments, the plurality of labeled datasets may be generated by a natural language machine learning model using various prompts. By modifying prompts that are provided to a natural language machine learning model, unique labeled datasets may be obtained and used to generate and train a plurality of instances of a classification machine learning model. Hence, the quality of the unique labeled datasets, and by extension, the prompts used to generate the unique labeled datasets may be determined and compared by analyzing classification outputs generated by the plurality of instances of the classification machine learning model.

In some embodiments, a classification machine learning model refers to a data construct that describes parameters, hyperparameters, and/or defined operations of a machine learning model that is configured to generate one or more classification outputs for input data. In some embodiments, a classification machine learning model is configured to generate one or more classification outputs that comprise a label selected from a plurality of labels. For example, a classification machine learning model may select a label from among two labels to perform binary classification, or a classification machine learning model may select a label from among three or more labels to perform multi-class classification.

In some embodiments, a classification output describes an output generated by a classification machine learning model. Generating a classification output may comprise determining one or more probabilities (e.g., a probability distribution) of an inference input data object being correctly assigned to one or more labels. In some embodiments, a classification output comprises a label that is assigned to an inference input data object.

In some embodiments, at step/operation 504, the computing entity 200 generates, by the labeled dataset preparation framework using the one or more instances of the classification machine learning model, a plurality of validation classification outputs for a validation portion of the one or more labeled datasets based on the one or more first parameter values. The instances of the classification machine learning models may respectively use the one or more first parameters to generate the plurality of validation classification outputs for the validation portion of the one or more labeled dataset. As such, the instances of the classification machine learning models that have been trained with the training portion of the one or more labeled datasets may be evaluated (e.g., with respect to accuracy) based on the plurality of validation classification outputs the instances of the classification machine learning models generate. In some embodiments, the validation portion of the one or more labeled datasets comprises a portion of the one or more labeled datasets (e.g., a fine-tuning dataset) that is allocated for validation and fine-tuning a machine learning model.

In some embodiments, at step/operation 506, the computing entity 200 generates, by using the labeled dataset preparation framework, one or more refined labeled datasets that are based on the one or more labeled datasets and a plurality of uncertainty scores associated with the plurality of validation classification outputs. For example, the validation portion of the one or more labeled datasets may comprise unbiased inputs and expected results that may be used by the data quality subsystem 606 to check the function and performance (e.g., accuracy) of the one or more trained instances of the classification machine learning model. That is, the plurality of validation classification outputs may be compared with the labels associated with the validation portion of the one or more labeled datasets.

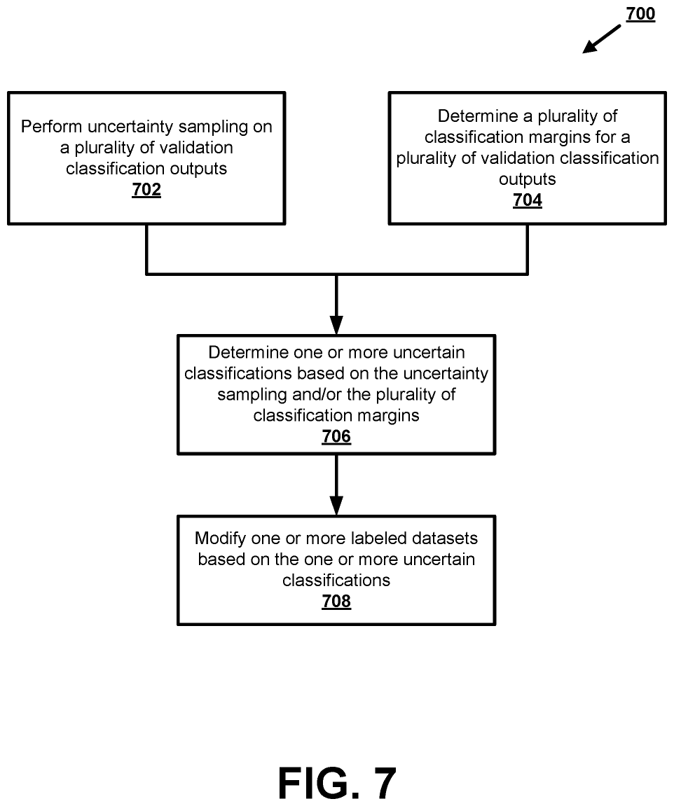

In some embodiments, the analysis of the plurality of validation classification outputs comprises determining one or more uncertain classifications from the plurality of validation classification outputs. In some embodiments, an uncertain classification describes a classification or classification output generated by a classification machine learning model that is determined to be potentially inaccurate. In some embodiments, uncertain classifications are determined by performing uncertainty sampling on a plurality of classification or determining a plurality of classification margins for the plurality of validation classification outputs (e.g., generated by one or more instances of a machine learning model that are trained with training data based on one or more labeled datasets). Generating one or more refined labeled datasets are described in further detail with respect to the description of FIG. 7.

Returning to FIG. 4, in some embodiments, at step/operation 406, the computing entity 200 trains and/or fine-tunes a classification machine learning model based on the one or more refined labeled datasets.

In some embodiments, training refers to a process of providing a machine learning model with training data such that the machine learning model may identify patterns in the training data that map one or more features to a target (e.g., a label). Training a machine learning model may comprise modifying one or more parameters of the machine learning model to store or capture patterns identified from training data. For example, one or more parameters of a machine learning model may be modified during training based on an observation of training data (e.g., a labeled dataset) comprising one or more data features and one or more labels that are associated with the one or more data features. The one or more parameters may be modified using one or more training techniques, such as back propagation of errors, gradient descent, and/or the like, to optimize a model with respect to one or more targets within the training data. According to various embodiments of the present disclosure, modifying one or more parameters of a machine learning model comprises determining one or more parameter values.

In some embodiments, fine-tuning comprises additional training of a previously trained machine learning model that is performed to update one or more parameters of the trained machine learning model to reflect new or updated data (e.g., refined labeled datasets). In some embodiments, fine-tuning comprises modifying one or more parameters of a machine learning model by determining one or more parameter values based on one or more refined labeled datasets.

In some embodiments, at step/operation 408, the computing entity 200 generates, using the classification machine learning model that is trained and/or fine-tuned based on the one or more refined labeled datasets, one or more inference classification outputs for inference input data.

In some embodiments, inference input data comprises data that is provided to a machine learning model to generate a classification output. For example, inference input data may comprise unlabeled data that is provided to a machine learning model (e.g., trained with one or more labeled datasets) to generate a classification output.

In some embodiments, at step/operation 410, the computing entity 200 initiates the performance of one or more prediction-based actions based on the one or more inference classification outputs. In some embodiments, the inference input data comprises an unlabeled document data object, the one or more inference classification output comprises a document classification/label for the unlabeled document data object, and the performance of the prediction-based actions are initiated based on the classification/label. In some embodiments, initiating performance of the one or more prediction-based actions based on the one or more inference classification outputs includes displaying one or more label assignments for one or more unlabeled document data objects using an output user interface. In some embodiments, initiating the performance of the one or more prediction-based actions based on the one or more inference classification outputs comprises, for example, performing a resource-based action (e.g., allocation of resource), generating a diagnostic report, generating and/or executing action scripts, generating alerts or messages, or generating one or more electronic communications. The one or more prediction-based actions may further include displaying visual renderings of the aforementioned examples of prediction-based actions in addition to values, charts, and representations associated with the optimum operation configuration using an output user interface.

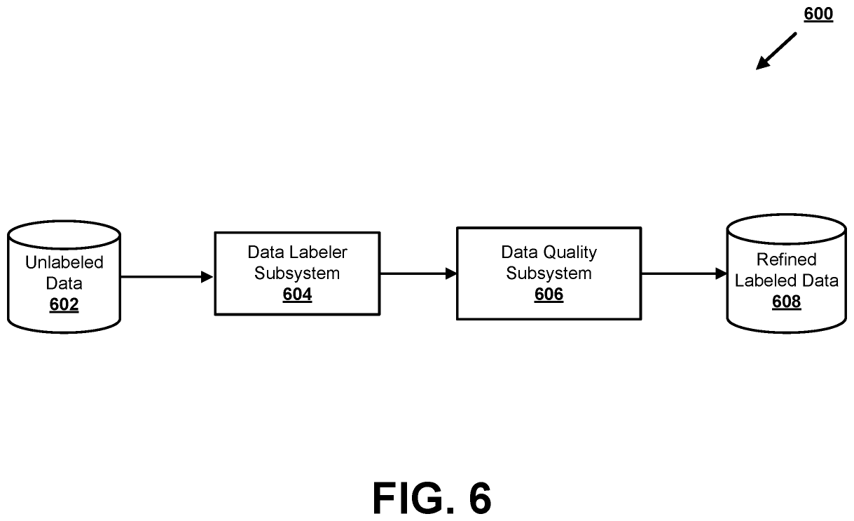

FIG. 6 depicts an example architecture of a labeled dataset preparation framework 600 in accordance with some embodiments of the present disclosure. As further depicted in FIG. 6, the labeled dataset preparation framework 600 comprises a data labeler subsystem 604 that is coupled to a data quality subsystem 606. In some embodiments, the data labeler subsystem 604 is configured to receive unlabeled data 602 and generate one or more labeled datasets (e.g., using a natural language machine learning model) from the unlabeled data.

According to various embodiments of the present disclosure, the data labeler subsystem 604 is configured to apply various techniques to generate the one or more labeled datasets. In some embodiments, the one or more labeled datasets are generated by a natural language machine learning model based on one or more prompts, such as a zero-shot prompt and/or one or more few-shot prompts (e.g., one-shot, two-shot, three-shot, etc.). In some embodiments, the one or more labeled datasets are generated based on human annotations.

In some embodiments, the data labeler subsystem 604 is further configured to provide one or more labeled datasets that are generated by the data labeler subsystem 604 to a data quality subsystem 606. The data quality subsystem 606 may be configured to use a training portion of the one or more labeled datasets to generate and train one or more instances of a classification machine learning model. As such, each of the one or more labeled datasets may be individually trained via one or more instances of a same classification machine learning model.

The data quality subsystem 606 may be further configured to generate a plurality of validation classification outputs by using the one or more trained instances of the classification machine learning model with a validation portion of the one or more labeled datasets. In some embodiments, the data quality subsystem 606 is configured to analyze the plurality of validation classification outputs to determine whether the one or more labeled datasets used to train the one or more instances of the classification machine learning model should be revised. The data quality subsystem 606 may generate refined labeled data 608 by modifying the one or more labeled datasets based on the analysis of the plurality of validation classification outputs. In some embodiments, the data quality subsystem 606 is configured to analyze the plurality of validation classification outputs by determining one or more uncertain classifications from the plurality of validation classification outputs.

FIG. 7 is a flowchart diagram of an example process 700 for generating refined labeled datasets in accordance with some embodiments of the present disclosure.

In some embodiments, the process 700 begins at step/operation 702 when the computing entity 200 performs uncertainty sampling on a plurality of validation classification outputs. In some embodiments, uncertainty sampling comprises determining one or more uncertain classifications from a plurality of validation classification outputs based on a plurality of probability distributions (e.g., determined by a classification machine learning model during inference) associated with the plurality of validation classification outputs. Uncertainty sampling may comprise generating a plurality of uncertainty scores for a plurality of validation classification outputs, which may then be used to determine given ones of the plurality of validation classification outputs comprising highest (e.g., top percentile or exceeding a threshold) uncertainty scores. In some embodiments, an uncertainty score comprises a data value that reflects an uncertainty with a validation classification output. An uncertainty score may be based on a prediction probability and/or a margin of prediction probabilities output by a machine learning model. In some embodiments, performing uncertainty sampling comprises (i) determining a plurality of prediction probabilities that are associated with a plurality of validation classification outputs, (ii) generating a plurality of uncertainty scores for the plurality of validation classification outputs based on the plurality of prediction probabilities, and (iii) determining one or more of the plurality of validation classification outputs comprising either (a) one or more top percentile uncertainty scores or (b) one or more uncertainty scores that exceed a threshold from the plurality of uncertainty scores.

In some embodiments, uncertainty sampling is performed by (i) determining a plurality of prediction probabilities associated with a plurality of validation classification outputs and (ii) generating a plurality of uncertainty scores for the plurality of validation classification outputs based on the plurality of prediction probabilities. An uncertainty score, for example, may include the prediction probability and/or an inverse of the prediction probability for a validation classification output. For example, an uncertainty score (e.g., 0.3, etc.) may reflect margin between a prediction probability (e.g., 0.7, etc.) and an upper limit (e.g., 1, etc.) for the prediction probability. In such a case, an uncertain classification may be assigned to a validation classification output with an uncertainty score that exceeds a threshold uncertainty (e.g., 0.2, etc.).

In some embodiments, determining one or more uncertain classifications comprises determining an uncertainty score, U(x), for a validation classification output by \hat{x}:

$$U ( x ) = 1 - P ( \hat{x} \vert x )$$

where x may represent a classification to be generated, \hat{x} may represent a most likely classification, and P (\hat{x}, x) is the prediction probability. In some embodiments, determining the one or more uncertain classifications comprises sorting uncertainty scores of the plurality of validation classification outputs in a descending order and identifying validation classification outputs comprising the largest uncertainty scores.

Alternatively, or simultaneously, the process 700 begins at step/operation 704 when the computing entity 200 determines a plurality of classification margins for a plurality of validation classification outputs.

In some embodiments, a classification margin comprises a margin between the prediction probabilities for one or more classifications output by a machine learning model for a validation data object from the validation portion of the one or more labeled datasets. The classification margin, for example, may include an uncertainty score for a particular validation classification output. In this case, the uncertainty score may be determined from a plurality of probability distributions (e.g., determined by a classification machine learning model during inference) associated with the plurality of validation classification outputs. Classifications comprising low classification margin may be prone to having incorrect ground truths. That is, a low classification margin may be representative of a classification where a first probable class and a second most probable class that are determined and used as a basis for performing the classification are almost equally likely, thereby resulting in a classification that is highly uncertain. In some embodiments, a classification margin is determined for a classification by (i) determining a first most likely prediction and a second most likely prediction associated with the classification and (ii) determining a difference between the first most likely prediction and the second most likely prediction.

In some embodiments, a classification margin, M(x), of a validation classification output is determined by M(x)=P (x1\hat{ }|x)−P(x2\hat{ }x) where x1\hat{ } and x2\hat{ } may represent first and second most likely classes that are used in generating the validation classification output. For example, an instance of a classification machine learning model may generate a validation classification output by generating a probability distribution comprising a plurality of class labels and generate the validation classification output based on a class label comprising a highest probability. As such, the first and second most likely classes may be retrieved from the probability distribution based on class labels comprising first and second highest probabilities, respectively.

In some embodiments, at step/operation 706, the computing entity 200 determines one or more uncertain classifications based on the uncertainty sampling and/or the determination of classification margin. The one or more uncertain classifications may comprise given ones of the plurality of validation classification outputs that are determined to be potentially and/or most likely inaccurate and thereby candidates for further review and/or modification. In some embodiments, the one or more uncertain classifications are determined based on given ones of the plurality of validation classification outputs comprising an uncertainty score that exceeds an uncertainty score threshold. In some embodiments, the one or more uncertain classifications are determined based on given ones of the plurality of validation classification outputs comprising a classification margin that exceeds a classification margin threshold. In some embodiments, the one or more uncertain classifications are determined based on given ones of the plurality of validation classification outputs comprising a combination of an uncertainty score that exceeds an uncertainty score threshold and a classification margin that exceeds a classification margin threshold.

In some embodiments, at step/operation 708, the computing entity 200 modifies one or more labeled datasets based on the one or more uncertain classifications. In some embodiments, modifying the one or more labeled datasets may comprise re-labeling (e.g., adding, removing, or replacing a label) one or more members of the one or more labeled datasets that are associated with the one or more uncertain classifications. As such, only a portion of the one or more labeled dataset may need to be modified. In some embodiments, modifying the one or more labeled datasets comprises (i) identifying one or more labels that are assigned to data from the one or more labeled datasets and associated with the one or more uncertain classifications and (ii) replacing the one or more identified labels with one or more corrective labels. In some embodiments, the one or more identified labels are replaced based on input from manual supervision or human-in-the-loop. In some embodiments, the one or more identified labels are replaced by using a natural language machine learning model to generate one or more corrective labels by prompt tuning the natural language machine learning model based on the one or more uncertain classifications.

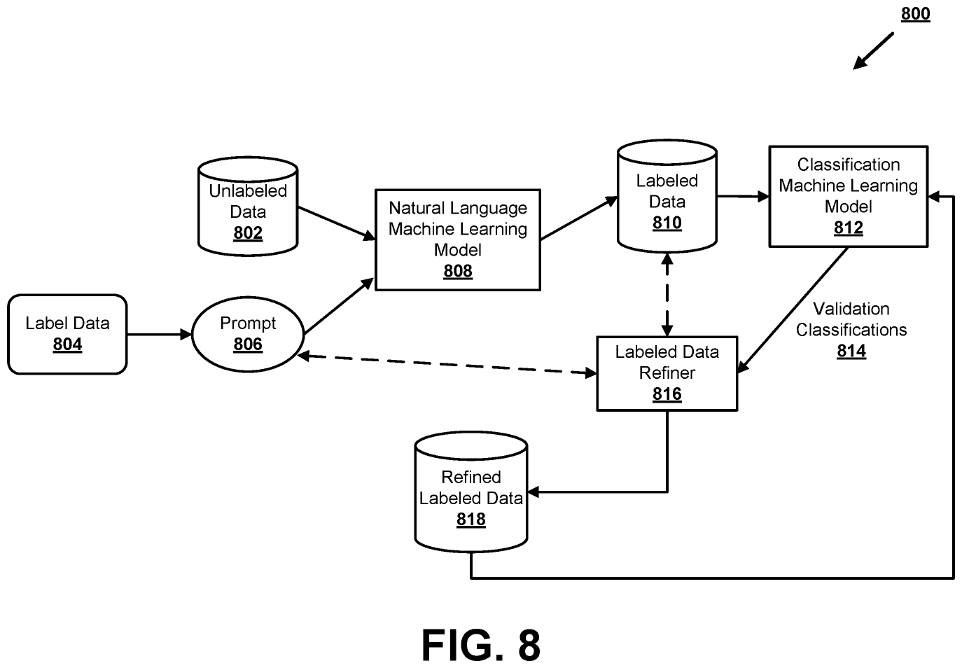

FIG. 8 is a data flow diagram of an example data labeling architecture 800 in accordance with some embodiments of the present disclosure.

The data labeling architecture 800 comprises a natural language machine learning model 808 that is configured to perform data labeling operations that are initiated by prompt 806 on unlabeled data 802. Label data 804 may comprise descriptions of one or more labels that are specified in prompt 806 for specifying the natural language machine learning model 808 on how to label the unlabeled data 802.

The natural language machine learning model 808 may generate labeled data 810 based on the unlabeled data 802 and prompt 806. The labeled data 810 may be used to train (e.g., one or more instances of) classification machine learning model 812 to generate validation classifications 814. The labeled data refiner 816 may generate refined labeled data 818 by modifying the labeled data 810 based on the validation classifications 814. For example, the labeled data refiner 816 may generate the refined labeled data 818 by (i) determining one or more uncertain classifications from the validation classifications 814, (ii) identifying one or more labels from the labeled data 810 that are associated with the one or more uncertain classifications, and (iii) replace the one or more identified labels from the labeled data 810 with one or more corrected labels. In some embodiments, the one or more identified labels are replaced based on input from manual supervision or human-in-the-loop. In some embodiments, the one or more identified labels are replaced by using natural language machine learning model 808 to generate one or more corrective labels by tuning prompt 806 based on the one or more uncertain classifications.

Accordingly, as described above, various embodiments of the present disclosure make important technical contributions to data annotation and classification systems that address the efficiency and reliability shortcomings of existing data analysis solutions. This approach improves the classification accuracy of classification machine learning models used in classifying unlabeled data. It is well-understood in the relevant art that there is typically a tradeoff between accuracy and training speed, such that it is trivial to improve training speed by reducing accuracy. Thus, the challenge is to improve training speed without sacrificing accuracy through innovative machine learning model architectures. Accordingly, some of the techniques of the present disclosure that improve accuracy without harming training speed, such as the techniques described herein, enable improving training speed given an improved accuracy. In doing so, some of the techniques described herein improve efficiency and speed of training classification machine learning models, thus reducing the number of computational operations needed and/or the amount of training data entries needed to train classification machine learning models. Accordingly, the techniques described herein improve the computational efficiency, storage-wise efficiency, and/or speed of training classification machine learning models.

The data labeling techniques of the present disclosure may be used, applied, and/or otherwise leveraged to generate a classification machine learning model, which may help in the computer interpretation and summarization of data, such as text. The classification machine learning model of the present disclosure may be leveraged to initiate the performance of various computing tasks that improve the performance of a computing system (e.g., a computer itself, etc.) with respect to various predictive actions performed by the computing entity 200, such as for the summarization of dialogs, chat comprehension, and/or the like. Example predictive actions may include the generation of an abstractive summary to summarize a call transcript and prediction action to automatically address aspects discussed during the call. For instance, the abstractive summary may be interpreted to determine a predictive action for addressing a concern and automatically initiating the action output.

In some examples, the computing tasks may include predictive actions that may be based on a prediction domain. A prediction domain may include any environment in which computing systems may be applied to achieve real-word insights, such as predictions (e.g., abstractive summaries, predictive intents, etc.), and initiate the performance of computing tasks, such as predictive actions (e.g., updating user preferences, providing account information, cancelling an account, adding an account, etc.) to act on the real-world insights. These predictive actions may cause real-world changes, for example, by controlling a hardware component, providing alerts, interactive actions, and/or the like.

Examples of prediction domains may include financial systems, clinical systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated data compliance actions, automated data access enforcement actions, automated adjustments to computing and/or human data access management, and/or the like.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: generating, by one or more processors and using a natural language machine learning model, a labeled dataset from unlabeled data based on one or more prompts that are associated with a data labeling task; generating, by the one or more processors, a first instance of a classification machine learning model by determining one or more first parameter values for the first instance of the classification machine learning model based on a training portion of the labeled dataset; generating, by the one or more processors and using the first instance of the classification machine learning model, a plurality of validation classification outputs for a validation portion of the labeled dataset; receiving, by the one or more processors, a refined labeled dataset that is based on the labeled dataset and a plurality of uncertainty scores associated with the plurality of validation classification outputs; generating, by the one or more processors, a second instance of the classification machine learning model by determining one or more second parameter values for the second instance of the classification machine learning model based on the refined labeled dataset; and generating, by the one or more processors and using the second instance of the classification machine learning model, one or more inference classification outputs.

Example 2. The computer-implemented method of example 1, wherein the natural language machine learning model comprises a generative pre-trained transformer.

Example 3. The computer-implemented method of any of the preceding examples, wherein generating the labeled dataset comprises: providing the one or more prompts to the natural language machine learning model; and generating the labeled dataset via the natural language machine learning model assigning one or more labels to the unlabeled dataset based on the one or more prompts.

Example 4. The computer-implemented method of any of the preceding examples, wherein the one or more prompts comprise an input sample that is associated with a description of the data labeling task.

Example 5. The computer-implemented method of any of the preceding examples, wherein the one or more prompts comprise one or more input-output pair examples that are associated with a description of the data labeling task.

Example 6. The computer-implemented method of any of the preceding examples further comprising determining the plurality of uncertainty scores based on a plurality of prediction probabilities or a plurality of classification margins that are associated with the plurality of validation classification outputs.

Example 7. The computer-implemented method of example 6 further comprising: determining the plurality of prediction probabilities; generating the plurality of uncertainty scores for the plurality of validation classification outputs based on the plurality of prediction probabilities; and determining one or more of the plurality of validation classification outputs comprising either (i) one or more top percentile uncertainty scores or (ii) one or more uncertainty scores that exceed a threshold from the plurality of uncertainty scores.

Example 8. The computer-implemented method of example 6 further comprising determining the plurality of classification margins by: for at least one of the plurality of validation classification outputs, determining a first most likely prediction and a second most likely prediction that are determined by the first instance of the classification machine learning model during the generating of the at least one of the plurality of validation classification outputs; and determining a difference between the first most likely prediction and the second most likely prediction.

Example 9. A computing system comprising memory and one or more processors communicatively coupled to the memory, the one or more processors configured to: generate, using a natural language machine learning model, a labeled dataset from unlabeled data based on one or more prompts that are associated with a data labeling task; generate a first instance of a classification machine learning model by determining one or more first parameter values for the first instance of the classification machine learning model based on a training portion of the labeled dataset; generate, using the first instance of the classification machine learning model, a plurality of validation classification outputs for a validation portion of the labeled dataset; receive a refined labeled dataset that is based on the labeled dataset and a plurality of uncertainty scores associated with the plurality of validation classification outputs; generate a second instance of the classification machine learning model by determining one or more second parameter values for the second instance of the classification machine learning model based on the refined labeled dataset; and generate, using the second instance of the classification machine learning model, one or more inference classification outputs.

Example 10. The computing system of example 9, wherein the one or more processors are further configured to generate the labeled dataset by: providing the one or more prompts to the natural language machine learning model; and generating the labeled dataset via the natural language machine learning model assigning one or more labels to the unlabeled dataset based on the one or more prompts.

Example 11. The computing system of example 9 or 10, wherein the one or more prompts comprise an input sample that is associated with a description of the data labeling task.

Example 12. The computing system of examples 9 through 11, wherein the one or more prompts comprise one or more input-output pair examples that are associated with a description of the data labeling task.

Example 13. The computing system of examples 9 through 12, wherein the one or more processors are further configured to determine the plurality of uncertainty scores based on a plurality of prediction probabilities or a plurality of classification margins that are associated with the plurality of validation classification outputs.

Example 14. The computing system of example 13, wherein the one or more processors are further configured to: determine the plurality of prediction probabilities; generate the plurality of uncertainty scores for the plurality of validation classification outputs based on the plurality of prediction probabilities; and determine one or more of the plurality of validation classification outputs comprising either (i) one or more top percentile uncertainty scores or (ii) one or more uncertainty scores that exceed a threshold from the plurality of uncertainty scores.

Example 15. The computing system of example 13, wherein the one or more processors are further configured to determine the plurality of classification margins by: for at least one of the plurality of validation classification outputs, determining a first most likely prediction and a second most likely prediction that are determined by the first instance of the classification machine learning model during the generating of the at least one of the plurality of validation classification outputs; and determining a difference between the first most likely prediction and the second most likely prediction.

Example 16. One or more non-transitory computer-readable storage media including instructions that, when executed by one or more processors, cause the one or more processors to: generate, using a natural language machine learning model, a labeled dataset from unlabeled data based on one or more prompts that are associated with a data labeling task; generate a first instance of a classification machine learning model by determining one or more first parameter values for the first instance of the classification machine learning model based on a training portion of the labeled dataset; generate, using the first instance of the classification machine learning model, a plurality of validation classification outputs for a validation portion of the labeled dataset; receive a refined labeled dataset that is based on the labeled dataset and a plurality of uncertainty scores associated with the plurality of validation classification outputs; generate a second instance of the classification machine learning model by determining one or more second parameter values for the second instance of the classification machine learning model based on the refined labeled dataset; and generate, using the second instance of the classification machine learning model, one or more inference classification outputs.

Example 17. The one or more non-transitory computer-readable storage media of example 16 further including instructions that, when executed by the one or more processors, cause the one or more processors to generate the labeled dataset by: providing the one or more prompts to the natural language machine learning model; and generating the labeled dataset via the natural language machine learning model assigning one or more labels to the unlabeled dataset based on the one or more prompts.

Example 18. The one or more non-transitory computer-readable storage media of example 16 or 17 further including instructions that, when executed by the one or more processors, cause the one or more processors determine the plurality of uncertainty scores based on a plurality of prediction probabilities or a plurality of classification margins that are associated with the plurality of validation classification outputs.

Example 19. The one or more non-transitory computer-readable storage media of example 18 further including instructions that, when executed by the one or more processors, cause the one or more processors to: determine the plurality of prediction probabilities; generate the plurality of uncertainty scores for the plurality of validation classification outputs based on the plurality of prediction probabilities; and determine one or more of the plurality of validation classification outputs comprising either (i) one or more top percentile uncertainty scores or one or (ii) more uncertainty scores that exceed a threshold from the plurality of uncertainty scores.

Example 20. The one or more non-transitory computer-readable storage media of example 18 further including instructions that, when executed by the one or more processors, cause the one or more processors to determine the plurality of classification margins by: for at least one of the plurality of validation classification outputs, determining a first most likely prediction and a second most likely prediction that are determined by the first instance of the classification machine learning model during the generating of the at least one of the plurality of validation classification outputs; and determining a difference between the first most likely prediction and the second most likely prediction.

Example 21. The computer-implemented method of example 1, wherein the at least one instance comprises a multi-class classifier and the method further comprises fine-tuning the at least one instance to generate the one or more inference classification outputs.

Example 22. The computer-implemented method of example 21, wherein the fine-tuning is performed by the one or more processors.

Example 23. The computer-implemented method of example 21, wherein the one or more processors are included in a first computing entity; and the fine-tuning is performed by one or more other processors included in a second computing entity.

Example 24. The computer-implemented method of example 1, wherein the one or more processors are included in a first computing entity; and the generating of the one or more inference classification outputs is performed by one or more other processors included in a second computing entity.

Example 25. The computing system of example 9, wherein the at least one instance comprises a multi-class classifier and the one or more processors are further configured to fine-tune the at least one instance to generate the one or more inference classification outputs.

Example 26. The computing system of example 25, wherein the fine-tuning is performed by the one or more processors.

Example 27. The computing system of example 25, wherein the one or more processors are included in a first computing entity; and the fine-tuning is performed by one or more other processors included in a second computing entity.

Example 28. The computing system of example 9, wherein the one or more processors are included in a first computing entity; and the generating of the one or more inference classification outputs is performed by one or more other processors included in a second computing entity.

Example 29. The one or more non-transitory computer-readable storage media of example 16, wherein the at least one instance comprises a multi-class classifier and the one or more processors are further configured to fine-tune the at least one instance to generate the one or more inference classification outputs.

Example 30. The one or more non-transitory computer-readable storage media of example 29, wherein the fine-tuning is performed by the one or more processors.

Example 31. The one or more non-transitory computer-readable storage media of example 29, wherein the one or more processors are included in a first computing entity; and the fine-tuning is performed by one or more other processors included in a second computing entity.

Example 32. The one or more non-transitory computer-readable storage media of example 16, wherein the one or more processors are included in a first computing entity; and the generating of the one or more inference classification outputs is performed by one or more other processors included in a second computing entity.

1. A computer-implemented method comprising:
generating, by one or more processors and using a natural language machine learning model, a labeled dataset from unlabeled data based on one or more prompts that are associated with a data labeling task;
generating, by the one or more processors, a first instance of a classification machine learning model by determining one or more first parameter values for the first instance of the classification machine learning model based on a training portion of the labeled dataset;
generating, by the one or more processors and using the first instance of the classification machine learning model, a plurality of validation classification outputs for a validation portion of the labeled dataset;
generating, by the one or more processors, a refined labeled dataset by modifying a label of the labeled dataset based on an uncertainty score of a plurality of uncertainty scores associated with the plurality of validation classification outputs; and
generating, by the one or more processors, a second instance of the classification machine learning model by fine-tuning the first instance of the classification machine learning model based on the refined labeled dataset, wherein the second instance of the classification machine learning model is configured to generate one or more inference classification outputs.

2. The computer-implemented method of claim 1, wherein the natural language machine learning model comprises a generative pre-trained transformer.

3. The computer-implemented method of claim 1, wherein generating the labeled dataset comprises:
providing the one or more prompts to the natural language machine learning model; and
assigning, by the natural language machine learning model, one or more labels to the unlabeled data based on the one or more prompts.

4. The computer-implemented method of claim 1, wherein the one or more prompts comprise an input sample that is associated with a description of the data labeling task.

5. The computer-implemented method of claim 1, wherein the one or more prompts comprise one or more input-output pair examples that are associated with a description of the data labeling task.

6. The computer-implemented method of claim 1 further comprising determining the plurality of uncertainty scores based on a plurality of prediction probabilities or a plurality of classification margins that are associated with the plurality of validation classification outputs.

7. The computer-implemented method of claim 6 further comprising:
determining the plurality of prediction probabilities;
generating the plurality of uncertainty scores for the plurality of validation classification outputs based on the plurality of prediction probabilities; and
determining one or more of the plurality of validation classification outputs comprising either (i) one or more top percentile uncertainty scores or (ii) one or more uncertainty scores that exceed a threshold from the plurality of uncertainty scores.

8. The computer-implemented method of claim 6 further comprising determining the plurality of classification margins by:
for at least one of the plurality of validation classification outputs, determining a first prediction and a second prediction that are determined by the first instance of the classification machine learning model during the generating of the at least one of the plurality of validation classification outputs, wherein the first prediction is associated with a first highest prediction score and the second prediction is associated with a second highest prediction score; and
determining a difference between the first prediction and the second prediction.

9. A computing system comprising one or more processors and at least one memory storing processor-executable instructions that, when executed by any of the one or more processors, causes the one or more processors to perform operations comprising:
generating, using a natural language machine learning model, a labeled dataset from unlabeled data based on one or more prompts that are associated with a data labeling task;
generating a first instance of a classification machine learning model by determining one or more first parameter values for the first instance of the classification machine learning model based on a training portion of the labeled dataset;
generating, using the first instance of the classification machine learning model, a plurality of validation classification outputs for a validation portion of the labeled dataset;
generating a refined labeled dataset by modifying a label of the labeled dataset based on an uncertainty score of a plurality of uncertainty scores associated with the plurality of validation classification outputs; and
generating a second instance of the classification machine learning model by fine-tuning the first instance of the classification machine learning model based on the refined labeled dataset, wherein the second instance of the classification machine learning model is configured to generate one or more inference classification outputs.

10. The computing system of claim 9, wherein to generate the labeled dataset the operations further comprise:
providing the one or more prompts to the natural language machine learning model; and
assigning, by the natural language machine learning model, one or more labels to the unlabeled data based on the one or more prompts.

11. The computing system of claim 9, wherein the one or more prompts comprise an input sample that is associated with a description of the data labeling task.

12. The computing system of claim 9, wherein the one or more prompts comprise one or more input-output pair examples that are associated with a description of the data labeling task.

13. The computing system of claim 9, wherein the operations further comprise determining the plurality of uncertainty scores based on a plurality of prediction probabilities or a plurality of classification margins that are associated with the plurality of validation classification outputs.

14. The computing system of claim 13, wherein the operations further comprise:
determining the plurality of prediction probabilities;
generating the plurality of uncertainty scores for the plurality of validation classification outputs based on the plurality of prediction probabilities; and
determining one or more of the plurality of validation classification outputs comprising either (i) one or more top percentile uncertainty scores or (ii) one or more uncertainty scores that exceed a threshold from the plurality of uncertainty scores.

15. The computing system of claim 13, wherein to determine the plurality of classification margins the operations further comprise:
for at least one of the plurality of validation classification outputs, determining a first prediction and a second prediction that are determined by the first instance of the classification machine learning model during the generating of the at least one of the plurality of validation classification outputs, wherein the first prediction is associated with a first highest prediction score and the second prediction is associated with a second highest prediction score; and
determining a difference between the first prediction and the second prediction.

16. One or more non-transitory computer-readable storage media including instructions that, when executed by one or more processors, cause the one or more processors to perform operations comprising:
generating, using a natural language machine learning model, a labeled dataset from unlabeled data based on one or more prompts that are associated with a data labeling task;
generating a first instance of a classification machine learning model by determining one or more first parameter values for the first instance of the classification machine learning model based on a training portion of the labeled dataset;
generating, using the first instance of the classification machine learning model, a plurality of validation classification outputs for a validation portion of the labeled dataset;
generating a refined labeled dataset that is based on the labeled dataset by modifying a label of the labeled dataset based on an uncertainty score of a plurality of uncertainty scores associated with the plurality of validation classification outputs; and
generating a second instance of the classification machine learning model by fine-tuning the first instance of the classification machine learning model based on the refined labeled dataset, wherein the second instance of the classification machine learning model is configured to generate one or more inference classification outputs.

17. The one or more non-transitory computer-readable storage media of claim 16, wherein the operations further comprise:
providing the one or more prompts to the natural language machine learning model; and
assigning, by the natural language machine learning model, one or more labels to the unlabeled data based on the one or more prompts.

18. The one or more non-transitory computer-readable storage media of claim 16, wherein the operations further comprise determining the plurality of uncertainty scores based on a plurality of prediction probabilities or a plurality of classification margins that are associated with the plurality of validation classification outputs.

19. The one or more non-transitory computer-readable storage media of claim 18, wherein the operations further comprise:
determining the plurality of prediction probabilities;
generating the plurality of uncertainty scores for the plurality of validation classification outputs based on the plurality of prediction probabilities; and
determining one or more of the plurality of validation classification outputs comprising either (i) one or more top percentile uncertainty scores or (ii) one or more uncertainty scores that exceed a threshold from the plurality of uncertainty scores.

20. The one or more non-transitory computer-readable storage media of claim 18, wherein to determine the plurality of classification margins the operations further comprise:
for at least one of the plurality of validation classification outputs, determining a first prediction and a second prediction that are determined by the first instance of the classification machine learning model during the generating of the at least one of the plurality of validation classification outputs, wherein the first prediction is associated with a first highest prediction score and the second prediction is associated with a second highest prediction score; and
determining a difference between the first prediction and the second prediction.
